(19) United States
(12) Patent Application Publication
(10) Pub. No.: US 2003/0187882 A1
(43) Pub. Date: Oct. 2, 2003

(54) Identifier query method, communication terminal, and network system

(75) Inventors: Tatuya Jinmei, Kanagawa-ken (JP); Masahiro Ishiyama, Kanagawa-ken (JP); Yuzo Tamada, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/394,175

(22) Filed: Mar. 24, 2003

(30) Foreign Application Priority Data
Mar. 27, 2002 (JP) 2002-089959

(51) Int. Cl. G06F 12/00

(52) U.S. Cl. 707/200

(57) ABSTRACT

In order to search for an IPv4 address of an IPv4 host H2 connected to an IPv4 network from the logical name of the IPv4 host H2 by an IPv6 host H1 connected to an IPv6 network and provided with an IPv6 address, a query is made via a cache server to a name server installed in the IPv4 network and configured to manage DNS information of the IPv4 host H2. The integrity of the IPv4 address obtained as a response to this query is verified by using DNSSEC. A pseudo IPv6 address is generated by using a translation prefix obtained from a router R1. By using the pseudo IPv6 address as a destination address, connection to the IPv4 address is established via a translator.

### BACKGROUND OF THE INVENTION

1. Field of the Invention

The present invention relates to an identifier query method, a communication terminal, and a network system that resolve addresses from the logical name of a communication terminal provided with an IPv4 address and connected to an IPv4 network by a communication terminal provided with an IPv6 address and connected to an IPv6 network.

2. Description of the Related Art

IPv6 has been introduced for next-generation IP addresses. In the known IP protocol, IPv4, addresses are defined as 32 bits. An IP address is used as an identifier for identifying an individual machine (node). If the number of machines connected to the Internet is explosively increased, there will be a shortage of addresses.

In order to solve this problem, IPv6 addresses defined as 128 bits in length have been established (IETF RFC2373). In IPv6, not only is the address space increased, but also the structure of the IP header is simplified, and thus, the load on routers is decreased, and the mechanism for automatically allocating IP addresses is improved.

However, the IP address system will not transition at one time from IPv4 to IPv6: rather, the IPv4 address system is gradually being shifted to the IPv6 address system. An experimental IPv6 network, which is referred to as “6bone”, has been constructed, and it is connected to a known IPv4 network by using a technique such as “IPv6 to IPv4 translator” or “tunneling”, which is described in detail in, for example, the document disclosed on www.6bone.net.

A known name resolution method using the domain name system (DNS) is described below with reference to FIGS. 7 and 8.

In this method, the IP address of a host (communication terminal) H200 connected to an IPv4 network 121 is searched for by using the DNS by a host (communication terminal) H100 provided with an IPv6 address and connected to an IPv6 network 120.

FIG. 7 illustrates a known network system. In FIG. 7, the IPv6 network 120 and the IPv4 network 121 are connected via a gateway 101. The gateway 101 contains an IPv6 to IPv4 translator 104 for converting IPv6 addresses into IPv4 addresses, and a cache server 102, which is referred to as “fake DNS” or “DNS-ALG (Application LevelGateway). A description is given below, assuming that the cache server 102 functions in a manner similar to the gateway 101 that can make access to both the IPv6 network 120 and the IPv4 network 121.

It is now considered that a query for “www.foobar.com”, which is the Fully Qualified Domain Name (FQDN) of the IPv4 host H200, is made from the IPv6 host H100 to the cache server 102. This system is referred to as “name lookup”, which is used for searching for the IP address from the FQDN. The host name, “www.foobar.com”, i.e., the IPv4 host H200, is connected to the IPv4 network 121.

A name server 103 may be installed anywhere as long as it can manage the foobar.com zone. Generally, however, the name server 103 is installed at a location near the IPv4 host H200. A description is given below, assuming that the name server 103 is connected to the IPv4 network 121.

A known identifier query sequence is discussed below with reference to FIG. 8. In step S1001, an application running on the IPv6 host H100 sends a library call to the resolver of the IPv6 host H100. In step S1002, upon receiving this call, the resolver requests the cache server 102 to provide the IPv6 address (AAAA RR, which is the resource record (RR) of the DNS) corresponding to “www.foobar.com”.

In S1003, upon receiving this query from the IPv6 host H100, the cache server 102 queries the name server 103, which manages the foobar.com zone, about AAAA RR based on the query domain name.

In the name server 103, however, only A RR is registered, and thus, this request is returned as a failure in step S1004.

Subsequently, in step S1005, the cache server 102 queries the name server 103 about the same name (in this case, “www.foobar.com”), i.e., A RR of the IPv4 address.

This query is successfully made, and in step S1006, as the IPv4 address of “www.foobar.com”, “x.y.z.w”, for example, is returned to the cache server 102. It is now assumed that the IPv4 address of “www.foobar.com” is “x.y.z.w”.

The cache server 102 already knows the prefix (P), which indicates the IPv4 network 121. Accordingly, in step S1007, the cache server 102 returns AAAA RR having the address “P::x.y.z.w” to the IPv6 host H100 in response to the query about “www.foobar.com” made from the IPv6 host H100. The address “P::x.y.z.w” is an IPv6 address converted from the IPv4 address “x.y.z.w”, in which the lower 32 bits are used for embedding the IPv4 address therein, and 92 bits are used for the prefix.

In step S1008, the resolver of the IPv6 host H100 returns the address “P::x.y.z.w” to the application, which is a query source.

The IPv6 host H100 then makes a connection request to “P::x.y.z.w” via the IPv6 to IPv4 translator 104, as in “connect P::x.y.z.w”. The IPv6 host H100 is then able to connect to the address “www.foobar.com”, which is the IPv4 host H200.

However, the above-described known identifier query method presents the problem that the response provided from the name server 103 may not be correct.

Generally, if a fake RR is provided in response to a query about RR to the name server 103, that is, if “spoofing” occurs, the IPv6 host H100 is connected to an incorrect address. If a dishonest person takes advantage of this “spoofing”, the IPv6 host H100 is accidentally connected to a www site different from the “www.foobar.com” site.

In order to solve this problem, a technique referred to as “DNSSEC” is available. In the DNSSEC technique, by providing a digital signature and conducting digital authentication between the name server and a query source according to a public key cryptosystem, the integrity of the response from the name server is verified. However, even if DNSSEC is implemented in the name server 103, the final response obtained by the IPv6 host H100 is AAAA RR, which has been dynamically generated, and thus, the IPv6 host H100, which is essentially the query source, cannot verify the signature. Accordingly, it is difficult to put DNSSEC into practical use.

As described above, in an environment in which an IPv4 network and an IPv6 network are mixed, the search results of the DNS are not totally reliable, and security checking by the DNSSEC is also difficult.

### SUMMARY OF THE INVENTION

Accordingly, in view of the above-described background, it is an object of the present invention to provide an identifier query method, a communication terminal, and a network system in which communication can be safely performed by preventing tampering, such as “spoofing” by using fake IP addresses (dishonest DNS responses) in a mixed environment of an IPv4 network and an IPv6 network.

According to one aspect of the present invention, there is provided an identifier query method for use in a network system which comprises a first communication terminal connected to a first network and provided with an identifier based on a first protocol, a second communication terminal connected to a second network and provided with an identifier based on a second protocol, and a name server configured to manage the identifier of the second communication terminal. The identifier query method includes the steps of: sending, from the first communication terminal to the name server, a query packet for making a query for the identifier of the second communication terminal from the logical name of the second communication terminal; receiving, by the name server, the query packet and returning at least the identifier based on the second protocol corresponding to the logical name of the second communication terminal in response to the query packet to the first communication terminal; and receiving, by the first communication terminal, the identifier based on the second protocol, providing a prefix of the second network obtained by a predetermined method for the identifier based on the second protocol so as to generate an identifier of the second communication terminal based on the first protocol, and making a request to connect to the second communication terminal by using the generated identifier based on the first protocol as a destination address.

Preferably, the first communication terminal may directly send the query packet to the name server.

Preferably, the network system may further include a cache server connected to at least the first network. The first communication terminal may send the query packet to the cache server, and the cache server may transfer the query packet to the name server based on content of the query packet.

Preferably, the name server may return an authentication key of the name server, together with the identifier based on the second protocol, to the first communication terminal. The first communication terminal may conduct authentication to verify the integrity of the received identifier based on the second protocol by using the received authentication key of the name server. When the authentication is successfully conducted, the first communication terminal may provide a prefix of the second network for the identifier based on the second protocol so as to generate an identifier of the second communication terminal based on the first protocol.

Preferably, the prefix of the second network may be provided from a router connected to the first communication terminal.

Preferably, the first protocol may be IPv6, and the second protocol may be IPv4.

According to another aspect of the present invention, there is provided a communication terminal, which serves as a first communication terminal connected to a first network and provided with an identifier based on a first protocol. The communication terminal includes: a query packet sender configured to send a query packet to a predetermined name server, the query packet being used for making a query for an identifier based on a second protocol of a second communication terminal connected to a second network from the logical name of the second communication terminal, the predetermined name server being configured to manage the identifier of the second communication terminal; a receiver configured to receive from the predetermined name server at least the identifier based on the second protocol corresponding to the logical name of the second communication terminal as a response to the query packet; and a connection request unit configured to provide a prefix of the second network obtained by a predetermined method for the identifier based on the second protocol so as to generate an identifier of the second communication terminal based on the first protocol, and to make a request to connect to the second communication terminal by using the generated identifier based on the first protocol as a destination address.

According to still another aspect of the present invention, there is provided an identifier query method for use in a first communication terminal connected to a first network and provided with an identifier based on a first protocol. The identifier query method includes the steps of: sending a query packet to a predetermined name server, the query packet being used for making a query for an identifier based on a second protocol of a second communication terminal connected to a second network from the logical name of the second communication terminal, the predetermined name server being configured to manage the identifier of the second communication terminal; receiving from the predetermined name server at least the identifier based on the second protocol corresponding to the logical name of the second communication terminal as a response to the query packet; and providing a prefix of the second network obtained by a predetermined method for the identifier based on the second protocol so as to generate an identifier of the second communication terminal based on the first protocol, and making a request to connect to the second communication terminal by using the generated identifier based on the first protocol as a destination address.

According to a further aspect of the present invention, there is provided a network system including: a first communication terminal connected to a first network and provided with an identifier based on a first protocol; a second communication terminal connected to a second network and provided with an identifier based on a second protocol; and a name server configured to manage the identifier of the second communication terminal. The first communication terminal includes a query packet sender configured to send a query packet to the name server, the query packet being used for making a query for the identifier of the second communication terminal from the logical name of the second communication terminal. The name server includes a receiver configured to receive the query packet, and a sender configured to send at least the identifier based on the second protocol corresponding to the logical name of the second communication terminal in response to the query packet to the first communication terminal. The first communication terminal further includes a receiver configured to receive the identifier based on the second protocol, and a connection request unit configured to provide a prefix of the second network obtained by a predetermined method for the identifier based on the second protocol so as to generate an identifier of the second communication terminal based on the first protocol, and to make a request to connect to the second communication terminal by using the generated identifier based on the first protocol as a destination address.

According to a yet further aspect of the present invention, there is provided a computer-readable program running on a first communication terminal connected to a first network and provided with an identifier based on a first protocol. The computer-readable program includes: a step of sending a query packet to a name server, the query packet being used for making a query for an identifier based on a second protocol of a second communication terminal connected to a second network from the logical name of the second communication terminal, the name server being configured to manage the identifier of the second communication terminal; a step of receiving at least the identifier based on the second protocol corresponding to the logical name of the second communication terminal from the name server as a response to the query packet; and a step of providing a prefix of the second network obtained by a predetermined method so as to generate an identifier of the second communication terminal based on the first protocol, and making a request to connect to the second communication terminal by using the generated identifier based on the first protocol as a destination address.

According to a further aspect of the present invention, there is provided a computer-readable program running on a first communication terminal connected to a first network and provided with an identifier based on a first protocol. The computer-readable program includes: a step of sending a query packet to a name server, the query packet being used for making a query for an identifier based on a second protocol of a second terminal connected to a second network from the logical name of the second communication terminal, the name server being configured to manage the identifier of the second communication terminal; a step of receiving the identifier based on the second protocol corresponding to the logical name of the second communication terminal and an authentication key of the name server from the name server as a response to the query packet; a step of conducting authentication to verify the identifier based on the second protocol by using the received authentication key; and a step of providing a prefix of the second network obtained by a predetermined method for the verified identifier so as to generate an identifier of the second communication terminal based on the first protocol, and making a request to connect to the second communication terminal by using the generated identifier as a destination address.

According to a further aspect of the present invention, there is provided a communication terminal, which serves as a first communication terminal provided with an identifier based on a first protocol. The communication terminal includes: a processor; a memory connected to the processor; an interface connected to a first network; and a program stored in the memory. The program includes: a function for sending a query packet to a predetermined name server via the interface, the query packet being used for making a query for an identifier based on a second protocol of a second communication terminal connected to a second network from the logical name of the second communication terminal, the predetermined name server being configured to manage the identifier of the second communication terminal; a function for receiving at least the identifier based on the second protocol corresponding to the logical name of the second communication terminal from the predetermined name server via the interface as a response to the query packet; and a function for providing a prefix of the second network obtained by a predetermined method so as to generate an identifier of the second communication terminal based on the first protocol, and making a request to connect to the second communication terminal by using the generated identifier as a destination address.

The device (communication terminal) of the present invention can be implemented as the method (identifier query method) of the present invention, and vice versa.

The device or the method of the present invention can be implemented as a program allowing a computer to execute the process corresponding to the present invention (or as a program allowing a computer to serve as the means corresponding to the present invention or allowing a computer to implement the functions corresponding to the present invention). The device or the method of the present invention can also be implemented as a recording medium in which the above-described program is recorded.

According to the present invention, it is possible to provide an identifier query method, a communication terminal, and a network system in which communication can be safely performed by preventing tampering, such as “spoofing” by using fake IP addresses (dishonest DNS responses) in a mixed environment of an IPv4 network and an IPv6 network.

For example, according to the present invention, DNS search results by DNSSEC can be verified in an IPv6 host, and communication can be safely performed by preventing “spoofing” using fake IP addresses.

### BRIEF DESCRIPTION OF THE DRAWINGS

FIG. 1 illustrates an example of the configuration of a network system according to an embodiment of the present invention;

FIG. 2 illustrates an example of the configuration of an IPv6 host according to the embodiment shown in FIG. 1;

FIG. 3 is a flowchart illustrating the processing performed by a resolver of the IPv6 host according to the embodiment shown in FIG. 1;

FIG. 4 illustrates an example of the sequence of an identifier query method according to the embodiment shown in FIG. 1;

FIG. 5 illustrates an example of the format of a router report message used in the embodiment shown in FIG. 1;

FIG. 6 illustrates another example of the configuration of the network system shown in FIG. 1;

FIG. 7 illustrates an example of the configuration of a known network system; and

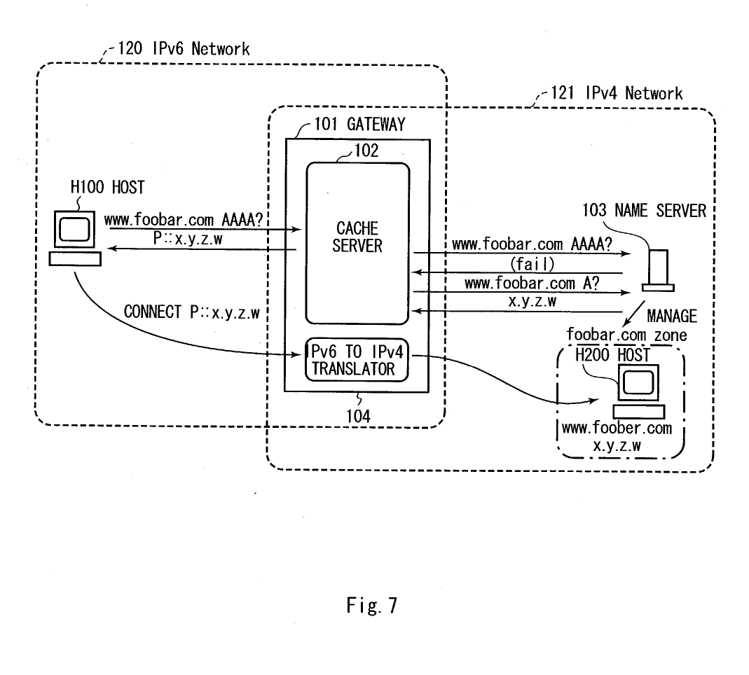

FIG. 8 illustrates a known identifier query sequence.

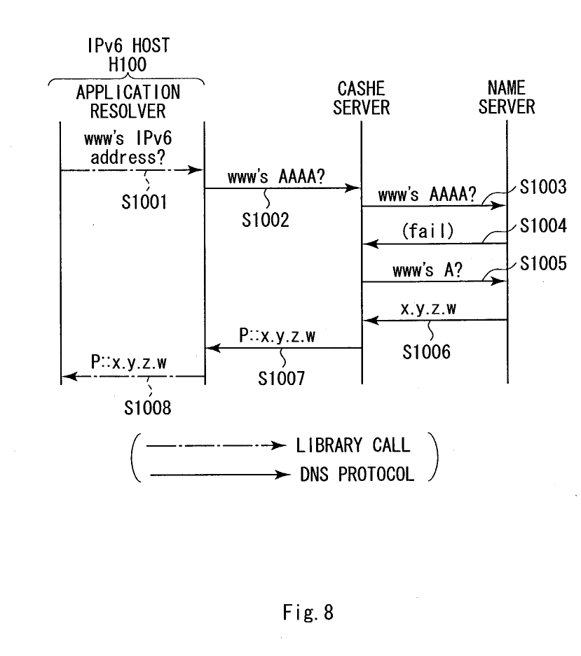

### DESCRIPTION OF THE PREFERRED EMBODIMENTS

The present invention is described in detail below with reference to the accompanying drawings through illustration of a preferred embodiment.

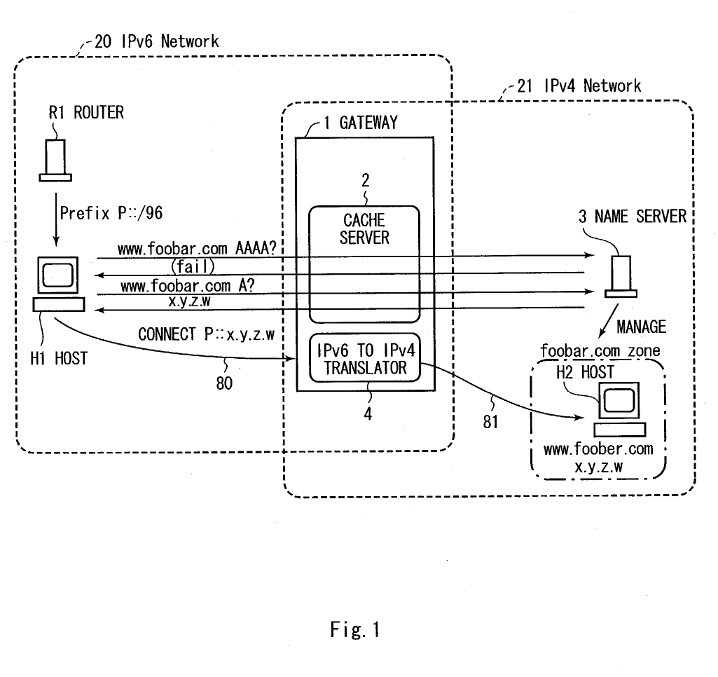

FIG. 1 illustrates an example of the configuration of a network system according to an embodiment of the present invention.

In FIG. 1, an IPv6 host (communication terminal) H1 provided with an IPv6 address is connected to an IPv6 network 20. An IPv4 host (communication terminal) H2 provided with an IPv4 address is connected to an IPv4 network 21. It is now assumed, for example, that the FQDN of the IPv4 host H2 is “www.foobar.com”, and that the IPv4 address corresponding to the FQDN “www.foobar.com” is “x.y.z.w”.

The IPv6 network 20 and the IPv4 network 21 are connected via a gateway 1. A cache server 2 transfers query requests from the IPv6 host H1 to a name server 3, and also receives responses from the name server 3 and transfers them to the IPv6 host H1. An IPv6 to IPv4 translator 4 receives a connection request from the IPv6 host H1, converts a destination IPv6 address (pseudo IPv6 address generated based on the IPv4 address, which is described in detail below) contained in the connection request to an IPv4 address, and transfers the connection request.

It is now assumed that the cache server 2 and the IPv6 to IPv4 translator 4 are integrated into the gateway 1.

The name server 3 manages the DNS information of the IPv4 host H2. The name server 3 may be installed anywhere as long as it can manage the foobar.com zone. For example, the name server 3 may be installed near the IPv4 host H2. Alternatively, the name server 3 may be installed in the IPv4 network 21 or in the IPv6 network 20. That is, the name server 3 may be installed anywhere within the area where query messages from the IPv6 host H1 reach. In the embodiment shown in FIG. 1, the name server 3 is installed in the IPv4 network 21.

A router R1 is located on a local link to which the IPv6 host H1 is connected.

Although each element of the network system shown in FIG. 1 consists of only a single device, a plurality of devices of the same element may be provided in the network system.

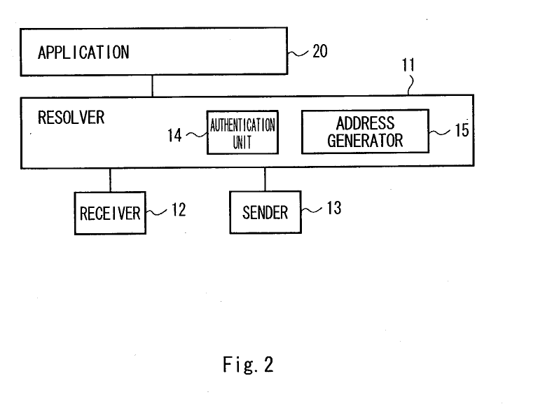

FIG. 2 illustrates the configuration of the IPv6 host H1 of this embodiment.

The IPv6 host H1 includes, as shown in FIG. 2, a resolver 11, a receiver 12, and a sender 13.

In the example shown in FIG. 2, an authentication unit 14 and an address generator 15 are contained in the resolver 11. However, one of or both the authentication unit 14 and the address generator 15 may be disposed outside the resolver 11. The provision of the authentication unit 14 may be omitted. In this embodiment, authentication is conducted by providing the authentication unit 14.

It is now assumed that the IPv6 host H1 is provided with software or hardware as required, such as a function for performing packet transfer according to the Transmission Control Protocol/Internet Protocol (TCP/IP) and an input/output interface function provided for the user.

In response to a request (for example, a library call) from a request source which wishes to obtain the IP address corresponding to a host name, the resolver 11 sends a query message to the name server 3, and receives a response message from the name server 3 and returns a response IPv6 address or a pseudo IPv6 address generated based on the IPv4 address to the request source. Details of the operation of the resolver 11 are given below.

The authentication unit 14 verifies the integrity of the IP address corresponding to the host name contained in the received response message.

The address generator 15 generates a pseudo IPv6 address based on the verified IPv4 address associated with the host name. In this case, the address generator 15 generates the pseudo IPv6 address by using a predetermined translation prefix and the received IPv4 address associated with the host name.

In this embodiment, the router R1, which is located on a local link to which the IPv6 host H1 is connected, adds a predetermined translation prefix to a message, such as a router advertisement message (RA (Router Advertisement)), and sends the message. The IPv6 host H1 then receives the message to obtain the predetermined translation prefix.

If the authentication unit 14 is not provided, the address generator 15 generates the pseudo IPv6 address based on the IPv4 address corresponding to the host name without checking the integrity of the IPv4 address.

The receiver 12 sends packets to the IPv4 network 21 and the IPv6 network 20. The sender 13 receives packets from the IPv4 network 21 and the IPv6 network 20.

The resolver 11 may be implemented by running a program using a central processing unit (CPU) or by hardware such as a semiconductor device. Similarly, the authentication unit 14 and the address generator 15 located outside the resolver 11 may be implemented by running a program using a CPU or by hardware such as a semiconductor device.

In the example shown in FIG. 2, the IPv6 host H1 is a general-purpose computer, and an application 16, which sends query requests to the resolver 11, is running. The request source for sending a query request to the resolver 11 is not necessarily implemented by a software process, and may be a processor formed of, for example, a semiconductor chip. The request source may be provided with other functions, such as a communication function and a browser function. Alternatively, the resolver 11 may be integrated into software or a processor formed of a semiconductor chip provided with certain functions, such as a communication function and a browser function.

Although the IPv6 host H1 is typically a general-purpose computer, it is not restricted to a computer. The IPv6 host H1 may be any type of machine, for example, a household electrical appliance, an audio/visual (AV) machine, or another information device, as long as it is provided with an Internet connecting function or a function for receiving and providing predetermined services by being connected to the Internet. A household electrical appliance, an AV machine, or an information device other than a computer may be provided with or without a CPU.

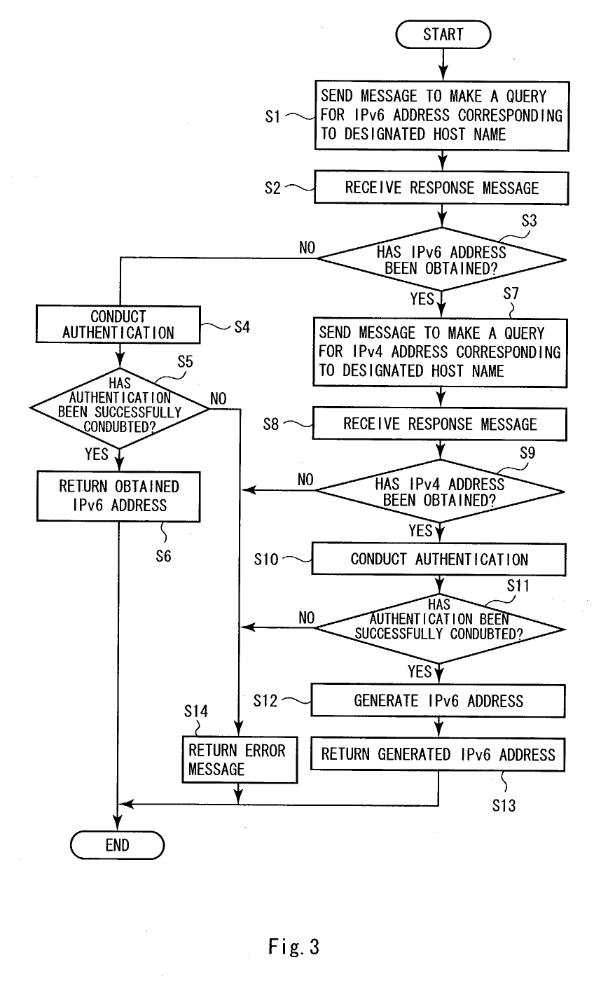

FIG. 3 is a flowchart illustrating an example of the processing performed by the IPv6 host H1 (resolver 11) of this embodiment.

In step S1, in response to a query request for the IPv6 address corresponding to the designated host name, the resolver 11 sends a message to make a query for the IPv6 address associated with the designated host name.

In step S2, the resolver 11 receives a response message for this query request.

It is then determined in step S3 whether the IPv6 address corresponding to the designated host name has been obtained. If the outcome of step S3 is yes, authentication is conducted in step S4. A determination is then made in step S5 as to whether authentication has been successfully conducted. If the answer of step S5 is yes, the obtained IPv6 address is returned to the request source. If it is determined in step S5 that authentication has failed, an error message is returned to the request source in step S14.

If it is found in step S3 that the IPv6 address associated with the designated host name has not been obtained, the process proceeds to step S7. In step S7, a query message for the IPv4 address corresponding to the designated host name is sent.

In step S8, the resolver 11 receives a response message for the query message.

If it is determined in step S9 that the IPv4 address corresponding to the designated host name has been obtained, authentication is conducted in step S10. If it is then determined in step S11 that authentication has been successfully conducted, an IPv6 address is generated based on the IPv4 address in step S12. Then, in step S13, the resolver 11 returns the generated IPv6 address to the request source. If it is found in step S11 that authentication has failed, the resolver 11 returns an error message to the request source in step S14.

If it is determined in step S9 that the IPv4 address associated with the designated host name has not been obtained, the resolver 11 returns an error message to the request source in step S14.

A description is now given of details of the search for the IP address of the IPv4 host H2 connected to the IPv4 network 21 by the IPv6 host H1 connected to the IPv6 network 20 by using the DNS.

The above-described processing indicated by the flowchart of FIG. 3 is an example only, and variations are possible.

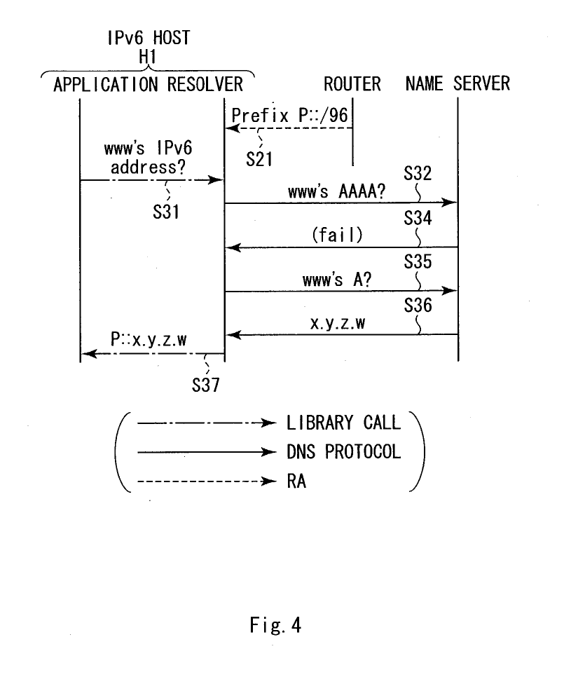

FIG. 4 illustrates one of the variations of the processing performed by the IPv6 host H1.

It is now considered that a query for the identifier (IPv6 address) corresponding to the FQDN (in this example, “www.foobar.com”) of the IPv4 host H2 is made from the IPv6 host H1 connected to the IPv6 network 20 to the name server 3, that is, “name lookup”, which searches for an IP address from a FQDN, is performed. As stated above, www.foobar.com, i.e., the IPv4 host H2, is connected to the IPv4 network 21.

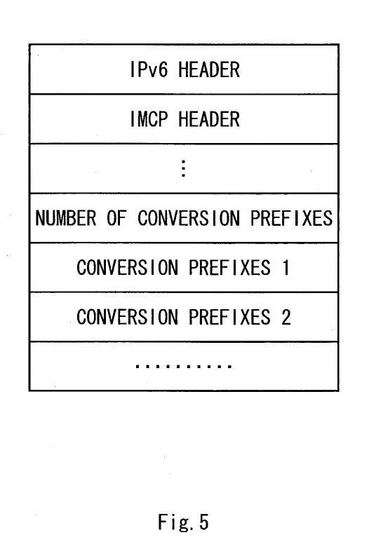

The router R1, which is located on a local link to which the IPv6 host H1 is connected, regularly sends router report messages. The IPv6 host H1 regularly receives the router report messages from the router R1 (IPv6 host H1 receives a router report message, for example, in step S21 of FIG. 4). The report message contains, as shown in FIG. 5, translation prefixes used for converting an IPv4 address format into an IPv6 address format. The translation prefixes are defined by the upper 96 bits of the IPv6 address format, and are represented by “P/96”. A packet having an IPv6 address provided with a translation prefix as the destination address reaches the IPv6 to IPv4 translator 4, and is transferred to the IPv4 network 21 as a packet having an IPv4 address without the translation prefix as the destination address. In the format of the report message shown in FIG. 5, the number of translation prefixes is variable. However, the number of translation prefixes may be determined in advance.

Referring back to FIG. 4, in step S31, the application 16 running on the IPv6 host H1 sends a query (for example, a library call) to the resolver 11 of the IPv6 host H1.

In step S32, upon receiving this query, the resolver 11 requests the cache server 2 to provide the IPv6 address (AAAA RR) corresponding to the FQDN “www.foobar.com”.

In step S33, upon receiving this query from the IPv6 host H1, the cache server 2 transfers it to the name server 3.

In the name server 3, however, only A RR is registered, and thus, this request is returned as a failure in step S34.

Subsequently, in step S35, the resolver 11 queries the name server 3 about the same name (in this case, “www.foobar.com”), i.e., A RR of the IPv4 address. This request is transferred from the cache server 2 to the name server 3.

This query is successfully made since the IPv4 address “x.y.z.w” associated with the FQDN “www.foobar.com” of the IPv4 host H2 is managed in the name server 3. Thus, in step S36, a response containing the IPv4 address corresponding to the queried FQDN is returned. That is, in this example, a response containing “x.y.z.w” as the IPv4 address corresponding to the “www.foobar.com” is returned.

The resolver 11 also receives SIG RR (digital signature) for this response together with the response (x.y.z.w) from the name server 3. The IPv6 host H1 verifies the integrity of the response (x.y.z.w) by using the public key (KEY RR) of the foobar.com zone, which has been obtained in advance. This verification is conducted by using the DNSSEC mechanism (details of DNSSEC are described in IETF RFC2535). If authentication is conducted neither on the IPv6 host H1 or the IPv4 host H2, the name server 3 does not have to send the SIG RR (digital signature) together with the response (x.y.z.w).

If the integrity of the response is verified by the DNSSEC, the resolver 11 generates a converted IPv6 address “P::x.y.z.w” from the received IPv4 address “x.y.z.w” by using a translation prefix obtained by the router report message.

If the resolver 11 possesses a plurality of translation prefixes, one of the prefixes is selected according to a predetermined criterion. For example, the translation prefix may be randomly selected. Alternatively, if there are valid prefixes and invalid prefixes for the IPv6 host H1, the resolver 11 may select the prefix that was used when the connection request made by the IPv6 host H1 in the past was successful. For translation prefixes having a certain lifetime, the prefix having the longest lifetime from now on may be selected.

If the resolver 11 does not possess a translation prefix at this stage, it may wait until it receives a router report message from the router R1, or it may query the router R1 about a translation prefix. If the resolver 11 cannot obtain a translation prefix, the processing is terminated as an error.

Then, in step S37, the resolver 11 returns “P::x.y.z.w” to the application 16, which is the query source.

The application 16 running on the IPv6 host H1 makes a connection request to the IPv6 address “P::x.y.z.w” via the IPv6 to IPv4 translator 4, as in “connect P::x.y.z.w”, so as to establish the TCP connection for “P::x.y.z.w”.

Since P is a translation prefix, the IPv6 host H1 is able to connect to “www.foobar.com”, which is the address of the IPv4 host H2, via the IPv6 to IPv4 translator 4 (see reference numerals 80 and 81 of FIG. 1).

As described above, by safely conducting the name resolution by using DNSSEC authentication, connection can be established from the IPv6 host H1 to the IPv4 host H2.

Variations of the above-described embodiment are as follows.

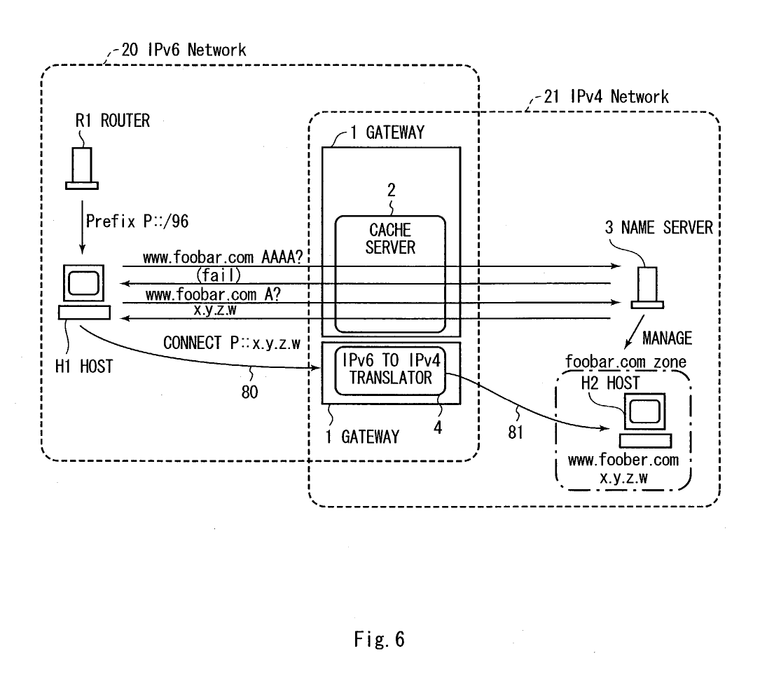

Although in this embodiment the cache server 2 and the IPv6 to IPv4 translator 4 are integrated into the same gateway 1, they may be loaded in different gateways, as shown in FIG. 6. Alternatively, the cache server 2 and the IPv6 to IPv4 translator 4 integrated in the same gateway 1 and those loaded in different gateways may be provided together.

Although in this embodiment the cache server 2 is loaded in the gateway 1, it may be loaded in a node other than the gateway 1. The same applies to the IPv6 to IPv4 translator 4.

Query messages from the IPv6 host H1 are transferred to the name server 3 via the cache server 2. However, the IPv6 host H1 may directly send query messages to the name server 3 without using the cache server 2, in which case, the provision of the cache server 2 becomes unnecessary.

In the aforementioned embodiment, translation prefixes are obtained by using report messages from the router R1. Alternatively, translation prefixes may be obtained from a service search server, such as the Dynamic Host Configuration Protocol v6 (DHCPv6) and the Service Location Protocol (SLP). Alternatively, the user or the administrator may set translation prefixes by operating the IPv6 host H1 directly or via another server in the same subnet. Alternatively, the administrator may set translation prefixes in another server in the same subnet, and the IPv6 host H1 may access the server automatically or by a user operation so as to obtain translation prefixes. Other methods are also possible for obtaining translation prefixes.

The above-described functions can be implemented by software. The aforementioned embodiment can also be implemented as a program allowing a computer to execute predetermined means (or as a program allowing a computer to serve as predetermined means or allowing a computer to implement predetermined functions). The embodiment can also be implemented as a computer-readable recording medium in which the above-mentioned program is recorded.

The configurations described in the embodiment of the present invention are examples only, and it is our intention that the invention should not be limited to the disclosed configurations. Part of the elements and functions of the disclosed configurations may be substituted by other elements and functions, part of the elements and functions of the disclosed configurations may be omitted, other elements and functions may be added to the disclosed configurations, or the added elements and functions may be combined with those in the disclosed configurations as desired. The present invention encompasses configurations logically equivalent to the disclosed configurations, configurations having elements and functions logically equivalent to those of the disclosed configurations, and configurations having elements and functions logically equivalent to the essential elements and functions of the disclosed configurations. The present invention also encompasses configurations to achieve the same or similar objects of the disclosed configurations, and configurations to obtain the same or similar advantages of the disclosed configurations.

Variations and modifications of the various elements disclosed in the embodiment of the present invention may be combined as desired.

The present embodiment encompasses various aspects of the present invention in various forms such as viewpoints, steps, concepts, and categories, for example, an individual device, a plurality of related devices, an overall system, elements in an individual device, and corresponding methods. Accordingly, the above-described aspects of the invention can be extracted from the disclosed embodiment of the present invention regardless of the configurations described in the embodiment.

As described above, the present invention is not restricted to the foregoing embodiment, and various modifications and variations can be made within the technical concept of the invention.

What is claimed is:

1. An identifier query method for use in a network system which comprises a first communication terminal connected to a first network and provided with an identifier based on a first protocol, a second communication terminal connected to a second network and provided with an identifier based on a second protocol, and a name server configured to manage the identifier of said second communication terminal, said identifier query method comprising the steps of:
sending, from said first communication terminal to said name server, a query packet for making a query for the identifier of said second communication terminal from a logical name of said second communication terminal;
receiving, by said name server, the query packet and returning at least the identifier based on the second protocol corresponding to the logical name of said second communication terminal in response to the query packet to said first communication terminal; and
receiving, by said first communication terminal, the identifier based on the second protocol, providing a prefix of the second network obtained by a predetermined method for the identifier based on the second protocol so as to generate an identifier of said second communication terminal based on the first protocol, and making a request to connect to said second communication terminal by using the generated identifier based on the first protocol as a destination address.

2. An identifier query method according to claim 1, wherein said first communication terminal directly sends the query packet to said name server.

3. An identifier query method according to claim 1, wherein:
said network system further comprises a cache server connected to at least said first network;
said first communication terminal sends the query packet to said cache server; and
said cache server transfers the query packet to said name server based on content of the query packet.

4. An identifier query method according to claim 1, wherein:
said name server returns an authentication key of said name server, together with the identifier based on the second protocol, to said first communication terminal; and
said first communication terminal conducts authentication to verify the integrity of the received identifier based on the second protocol by using the received authentication key of said name server, and, when the authentication is successfully conducted, said first communication terminal provides a prefix of the second network for the identifier based on the second protocol so as to generate an identifier of said second communication terminal based on the first protocol.

5. An identifier query method according to claim 1, wherein the prefix of the second network is provided from a router connected to said first communication terminal.

6. An identifier query method according to claim 1, wherein the first protocol is IPv6, and the second protocol is IPv4.

7. A communication terminal, which serves as a first communication terminal connected to a first network and provided with an identifier based on a first protocol, comprising:
a query packet sender configured to send a query packet to a predetermined name server, the query packet being used for making a query for an identifier based on a second protocol of a second communication terminal connected to a second network from a logical name of said second communication terminal, the predetermined name server being configured to manage the identifier of said second communication terminal;
a receiver configured to receive from said predetermined name server at least the identifier based on the second protocol corresponding to the logical name of said second communication terminal as a response to the query packet; and
a connection request unit configured to provide a prefix of the second network obtained by a predetermined method for the identifier based on the second protocol so as to generate an identifier of said second communication terminal based on the first protocol, and to make a request to connect to said second communication terminal by using the generated identifier based on the first protocol as a destination address.

8. A communication terminal according to claim 7, wherein said query packet sender directly sends the query packet to said predetermined name server.

9. A communication terminal according to claim 7, wherein:
said query packet sender sends the query packet to a cache server connected to at least the first network; and
said cache server transfers the query packet to said predetermined name server based on content of the query packet.

10. A communication terminal according to claim 7, wherein:
said receiver receives an authentication key of said predetermined name server, together with the identifier based on the second protocol, as a response to the query packet;
said first communication terminal further comprises an authentication unit configured to conduct authentication to verify the integrity of the identifier based on the second protocol by using the authentication key received by said receiver; and
when the authentication is successfully conducted by said authentication unit, said connection request unit provides the prefix of the second network for the identifier based on the second protocol so as to generate an identifier of said second communication terminal based on the first protocol, and makes a request to connect to said second communication terminal by using the generated identifier based on the first protocol as a destination address.

11. A communication terminal according to claim 7, wherein the prefix of the second network is provided from a router connected to said first communication terminal.

12. A communication terminal according to claim 7, wherein the first protocol is IPv6, and the second protocol is IPv4.

13. An identifier query method for use in a first communication terminal connected to a first network and provided with an identifier based on a first protocol, said identifier query method comprising the steps of:
sending a query packet to a predetermined name server, the query packet being used for making a query for an identifier based on a second protocol of a second communication terminal connected to a second network from a logical name of said second communication terminal, said predetermined name server being configured to manage the identifier of said second communication terminal;
receiving from said predetermined name server at least the identifier based on the second protocol corresponding to the logical name of said second communication terminal as a response to the query packet; and
providing a prefix of the second network obtained by a predetermined method for the identifier based on the second protocol so as to generate an identifier of said second communication terminal based on the first protocol, and making a request to connect to said second communication terminal by using the generated identifier based on the first protocol as a destination address.

14. An identifier query method according to claim 13, wherein said first communication terminal directly sends the query packet to said predetermined name server.

15. An identifier query method according to claim 13, wherein:
said first communication terminal sends the query packet to a cache server connected to at least the first network; and
said cache server transfers the query packet to said predetermined name server based on content of the query packet.

16. An identifier query method according to claim 13, wherein:
said first communication terminal receives an authentication key of said predetermined name server, together with the identifier based on the second protocol, from said predetermined name server as a response to the query packet; and
said first communication terminal conducts authentication to verify the integrity of the identifier based on the second protocol by using the received authentication key of said predetermined name server, and, when the authentication is successfully conducted, said first communication terminal provides the prefix of the second network for the identifier based on the second protocol so as to generate an identifier of said second communication terminal based on the first protocol.

17. An identifier query method according to claim 13, wherein the prefix of the second network is provided from a router connected to said first communication terminal.

18. An identifier query method according to claim 13, wherein the first protocol is IPv6, and the second protocol is IPv4.

19. A network system comprising:
a first communication terminal connected to a first network and provided with an identifier based on a first protocol;
a second communication terminal connected to a second network and provided with an identifier based on a second protocol; and
a name server configured to manage the identifier of said second communication terminal, wherein:
said first communication terminal comprises a query packet sender configured to send a query packet to said name server, the query packet being used for making a query for the identifier of said second communication terminal from a logical name of said second communication terminal;
said name server comprises a receiver configured to receive the query packet, and a sender configured to send at least the identifier based on the second protocol corresponding to the logical name of said second communication terminal in response to the query packet to said first communication terminal; and
said first communication terminal further comprises a receiver configured to receive the identifier based on the second protocol, and a connection request unit configured to provide a prefix of the second network obtained by a predetermined method for the identifier based on the second protocol so as to generate an identifier of said second communication terminal based on the first protocol, and to make a request to connect to said second communication terminal by using the generated identifier based on the first protocol as a destination address.

20. A network system according to claim 19, wherein said query packet sender of said first communication terminal directly sends the query packet to said name server.

21. A network system according to claim 19, further comprising a cache server connected to at least the first network, wherein:
said query packet sender of said first communication terminal sends the query packet to said cache server; and
said cache server comprises a transfer unit configured to transfer the query packet to said name server based on content of the query packet.

22. A network system according to claim 19, wherein:
said sender of said name server returns an authentication key of said name server, together with the identifier based on the second protocol, to said first communication terminal;
said receiver of said first communication terminal receives the authentication key of said name server, together with the identifier based on the second protocol, as a response to the query packet, said first communication terminal further comprising an authentication unit configured to conduct authentication to verify the integrity of the identifier based on the second protocol by using the authentication key received by said receiver; and
when the authentication is successfully conducted by said authentication unit, said connection request unit of said first communication terminal provides the prefix of the second network to the identifier based on the second protocol so as to generate an identifier of said second communication terminal based on the first protocol, and makes a request to connect to said second communication terminal by using the generated identifier based on the first protocol as a destination address.

23. A network system according to claim 19, wherein the prefix of the second network is provided from a router connected to said first communication terminal.

24. A network system according to claim 19, wherein the first protocol is IPv6, and the second protocol is IPv4.

25. A computer-readable program running on a first communication terminal connected to a first network and provided with an identifier based on a first protocol, said computer-readable program comprising:
a step of sending a query packet to a name server, the query packet being used for making a query for an identifier based on a second protocol of a second communication terminal connected to a second network from a logical name of said second communication terminal, said name server being configured to manage the identifier of said second communication terminal;
a step of receiving at least the identifier based on the second protocol corresponding to the logical name of said second communication terminal from said name server as a response to the query packet; and
a step of providing a prefix of the second network obtained by a predetermined method so as to generate an identifier of said second communication terminal based on the first protocol, and making a request to connect to said second communication terminal by using the generated identifier based on the first protocol as a destination address.

26. A computer-readable program running on a first communication terminal connected to a first network and provided with an identifier based on a first protocol, said computer-readable program comprising:
a step of sending a query packet to a name server, the query packet being used for making a query for an identifier based on a second protocol of a second terminal connected to a second network from a logical name of said second communication terminal, said name server being configured to manage the identifier of said second communication terminal;
a step of receiving the identifier based on the second protocol corresponding to the logical name of said second communication terminal and an authentication key of said name server from said name server as a response to the query packet;
a step of conducting authentication to verify the identifier based on the second protocol by using the received authentication key; and
a step of providing a prefix of the second network obtained by a predetermined method for the verified identifier so as to generate an identifier of said second communication terminal based on the first protocol, and making a request to connect to said second communication terminal by using the generated identifier as a destination address.

27. A communication terminal, which serves as a first communication terminal provided with an identifier based on a first protocol, comprising:
a processor;
a memory connected to said processor;
an interface connected to a first network; and
a program stored in said memory,
said program comprising:
a function for sending a query packet to a predetermined name server via said interface, the query packet being used for making a query for an identifier based on a second protocol of a second communication terminal connected to a second network from a logical name of said second communication terminal, said predetermined name server being configured to manage the identifier of said second communication terminal;
a function for receiving at least the identifier based on the second protocol corresponding to the logical name of said second communication terminal from said predetermined name server via said interface as a response to the query packet; and
a function for providing a prefix of the second network obtained by a predetermined method so as to generate an identifier of said second communication terminal based on the first protocol, and making a request to connect to said second communication terminal by using the generated identifier as a destination address.
